(19) United States
(12) Patent Application Publication
(10) Pub. No.: US 2025/0379340 A1
(43) Pub. Date: Dec. 11, 2025

(54) Low H-Field Tab Configuration for a Cylindrical-Winding Battery

(71) Applicant: Google LLC, Mountain View, CA (US)

(72) Inventors: Shengyin Ding, Cupertino, CA (US); Yuchu He, Mountain View, CA (US)

(73) Assignee: Google LLC, Mountain View, CA (US)

(21) Appl. No.: 19/301,106

(22) Filed: Aug. 15, 2025

Related U.S. Application Data
(60) Provisional application No. 63/838,298, filed on Jul. 3, 2025.

(51) Int. Cl. H01M 50/538; H01M 10/0587; H01M 50/536

(52) U.S. Cl. CPC H01M 50/538; H01M 10/0587; H01M 50/536

(57) ABSTRACT

The present document describes a low magnetic field (H-field) tab configuration for a cylindrical-winding battery. The battery design is a rolled and stacked battery, with two or more winding rolls of cathode and anode layers separated by insulation layers, the winding rolls also being separated by a distance with the distance, in some embodiments, filled with a dielectric material. A first tab is electrically connected to a first layer of the plurality of layers, the first layer having a first polarity. A second tab electrically connected to a second layer of the plurality of layers, the second layer having an opposite polarity to the first layer. The second tab is configured to at least partially overlap a portion of the first tab. The tab configuration causes the battery to produce a reduced H-field when compared with a battery having non-overlapping tabs.

### CROSS-REFERENCE TO RELATED APPLICATION

This application claims the benefit of U.S. Provisional Patent Application Ser. No. 63/838,298 filed on Jul. 3, 2025, the disclosure of which is incorporated by reference herein in its entirety.

### BRIEF SUMMARY

The present document describes a low magnetic field (H-field) tab configuration for a cylindrical-winding battery. The battery design is a rolled and stacked battery, with one or more winding rolls of cathode and anode layers separated by insulation layers. A first tab is electrically connected to a first layer of the plurality of layers, the first layer having a first polarity. A second tab electrically connected to a second layer of the plurality of layers, the second layer having an opposite polarity to the first layer. The second tab is configured to overlap a portion of the first tab. The tab configuration causes the battery to produce a reduced H-field when compared with a battery having non-overlapping tabs. This substantially mitigates unwanted effects of the H-field, such as electronic noise (eNoise) in a speaker of an electronic device when the electronic device includes both the battery and a speaker or other components, which may be negatively affected by H-fields.

In an example, a battery is disclosed. The battery has a symmetry about an axis and includes a plurality of layers. The plurality of layers includes alternating cathode and anode layers, the alternating cathode and anode layers electrically isolated from one another. The alternating anode and cathode layers are disposed such that the plurality of layers define a cylindrical-winding roll about the axis. The battery further includes a first tab electrically connected to a first layer of the plurality of layers, the first layer having a first polarity. The battery further includes a second tab electrically connected to a second layer of the plurality of layers, the second layer having a second polarity, the second polarity opposite to the first polarity and the second tab configured to overlap the first tab.

This summary is provided to introduce simplified concepts of a low H-field tab configuration for a cylindrical-winding battery, which are further described below in the Detailed Description. This summary is not intended to identify essential features of the claimed subject matter.

### BRIEF DESCRIPTION OF THE DRAWINGS

The details of one or more aspects of a low H-field tab configuration for a cylindrical-winding battery are described in this document with reference to the following drawings. The same numbers are used throughout the drawings to reference like features and components:

FIG. 1 illustrates an example implementation of a standard cylindrical-winding battery configuration;

FIG. 2 illustrates an example tab placement for a low H-field tab configuration for a cylindrical-winding battery;

FIG. 3 illustrates an example orientation of the tabs of FIG. 2 relative to one another for a low H-field tab configuration for a cylindrical-winding battery;

FIG. 4 illustrates an example folding of one of the tabs of FIG. 3 for a low H-field tab configuration for a cylindrical-winding battery;

FIG. 5 illustrates an example overlap configuration for the tabs of FIG. 2; and

FIG. 6 illustrates a comparative H-field propagation between a standard tab configuration and a low H-field tab configuration for a cylindrical-winding battery.

### DETAILED DESCRIPTION

The present document describes a low H-field tab configuration for a cylindrical-winding battery. Electric current running through a battery generates a magnetic field (H-field), which can induce nearfield coupling (e.g., electromagnetic coupling) with a nearby electronic circuit and cause unwanted electromagnetic interference. In some examples, this nearfield coupling is presented in the form of electronic noise (eNoise) or electromagnetic interference (EMI), which can produce undesirable effects. For example, an extra, audible, tonal sound (e.g., crackling, humming) may be present in a speaker. The battery design is a rolled and stacked battery, with one or more winding rolls of cathode and anode layers separated by insulation layers. The one or more winding rolls are electrically connected to two tabs, with a first tab connecting to the anode layers and a second tab connecting to the cathode layers (equivalently or alternately, the first tab can be connected to the cathode layers and the second tab can be connected to the anode layers). The flow of electricity in the battery, including the surface current, may be mathematically represented by an electromotive force:

$$ϵ = \int \vec{E} \cdot d \vec{l} \qquad Eq . 1$$

Eq. 1 shows an electromotive force e being equal to an electric field (E-field, \vec{E}) integrated over a distance and direction (d\vec{l}). Faraday's Law further states:

$$ϵ = - \frac{d}{dt} {Φ}_{B} \qquad Eq . 2$$

Eq. 2 equates ϵ with a changing magnetic flux (Φ_{B}), which may be defined as:

$${Φ}_{B} = {\int }_{S} {μ}_{0} \vec{H} \cdot d \vec{A} \qquad Eq . 3$$

Eq. 3 shows an H-field (\vec{H}) integrated with respect to an area and direction (d\vec{A}). Eqs. 1, 2, and 3 demonstrate that a current, such as an induced surface current, may in turn motivate an H-field. Additionally, there may be a direct correlation between the strength and/or density of E and the associated H-field, as demonstrated by Eqs. 1, 2, and 3. Thus, a battery is provided for devices (e.g., small form factor devices) that reduces EMI (e.g., eNoise) typically created between a battery and a nearby electronic component (e.g., speaker, main logic board, circuit, etc.). By way of example, a speaker in an earbud can experience EMI via coupling its H-field with the H-field from the battery current, thus passing on unwanted noise artifacts to an end user. Reduction of the surface current on the battery therefore lowers the associated H-field, which in turn lowers effects from EMI. Additionally or alternately, lowering an H-field produced by a configuration of the tabs will also lower effects from EMI. The disclosed battery configuration thereby increases the effectiveness, efficiency, and user satisfaction with devices and systems using the battery.

While features and concepts of the described techniques for a low H-field tab configuration for a cylindrical-winding battery can be implemented in any number of different environments, aspects are described in the context of the following examples.

### Example Batteries

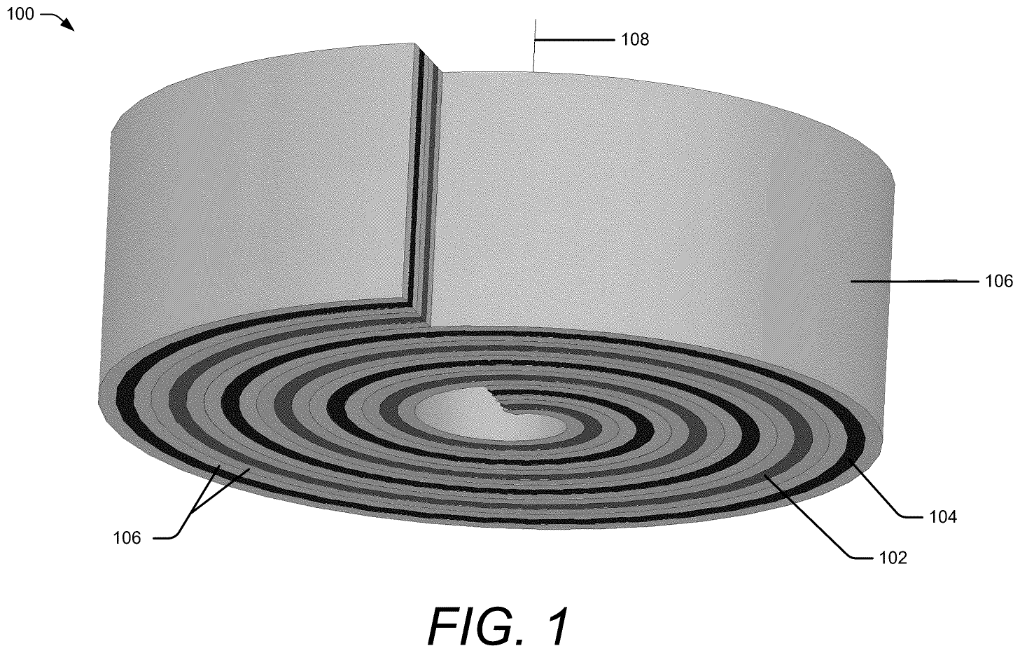

FIG. 1 illustrates an example implementation of a standard cylindrical-winding battery 100 configuration. The battery 100 includes an anode layer 102, a cathode layer 104, and an insulative layer or layers 106. The layers 102, 104, and 106 are wound around a central axis 108. The battery 100 may be a stacking cell battery, a coin cell battery, a button cell battery, or any other battery with a circular form factor. The layers 102, 104, and 106 are wound in a single direction around the central axis 108 such that they form alternating anode, cathode, and insulation areas.

The configuration of the alternating layers may, in aspects, produce a current along the surface of the battery 100, where the surface normal is in the direction of the indicated central axis line 108. As shown in Eqs. 1 through 3, this surface current will induce a corresponding H-field. The surface current for the battery 100 may, in some examples, have a marked unwanted effect on other electronic components if the battery 100 is used in a device where other electronic components are placed within range of the produced H-field. For example, a speaker in an earbud may have static or other unwanted eNoise due to the small form factor of an earbud placing the speaker in close proximity to the battery 100.

It should be noted that, in some implementations, the example implementation of a standard cylindrical-winding battery 100 configuration of FIG. 1 can be configured to realize a lower-emission configuration. Consider the anode layer 102 and the cathode layer 104. The anode layer 102, in aspects, has an overall length Lₐ, and the cathode layer 104, in aspects, has an overall length L_{c}. The relation of the lengths Lₐ and L_{c} may be expressed as:

$${L}_{a} = {L}_{c} + δ \qquad Eq . 4$$

Eq. 4 expresses the difference between Lₐ and L_{c} by a difference parameter δ. In an ideal limit, δ=0 and Equation 4 becomes Lₐ=L_{c}. In such a configuration, an H-field generated by a current flowing through the anode layer 102 is equal to and opposite from an H-field generated by a current flowing through the cathode layer 104. In such an example, the overall H-field generated by the battery 100 is zero.

In real-world implementations, it may not be possible to manufacture the battery 100 such that δ=0 exactly. In some examples, there is an acceptability threshold K such that:

$$δ \leq κ \qquad Eq . 5$$

Eq. 5 expresses the acceptable variability of δ. The acceptability threshold K can be, in some examples, a manufacturing parameter determined by a maximum acceptable net H-field for the battery 100. In aspects, configuring the battery 100 such that Eq. 5 is satisfied can be expressed as Lₐ being substantially the same length as L_{c}. In some examples, the overall H-field of the battery 100 can be further minimized by placement of battery tabs (not pictured in FIG. 1) for the anode layer 102 and the cathode layer 104.

The battery 100 may be a Li-ion battery. Various Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various anode materials, including graphite-based anodes, silicon (Si), graphene, and other cation intercalation/insertion/alloying anode materials.

### Example Tab Configurations

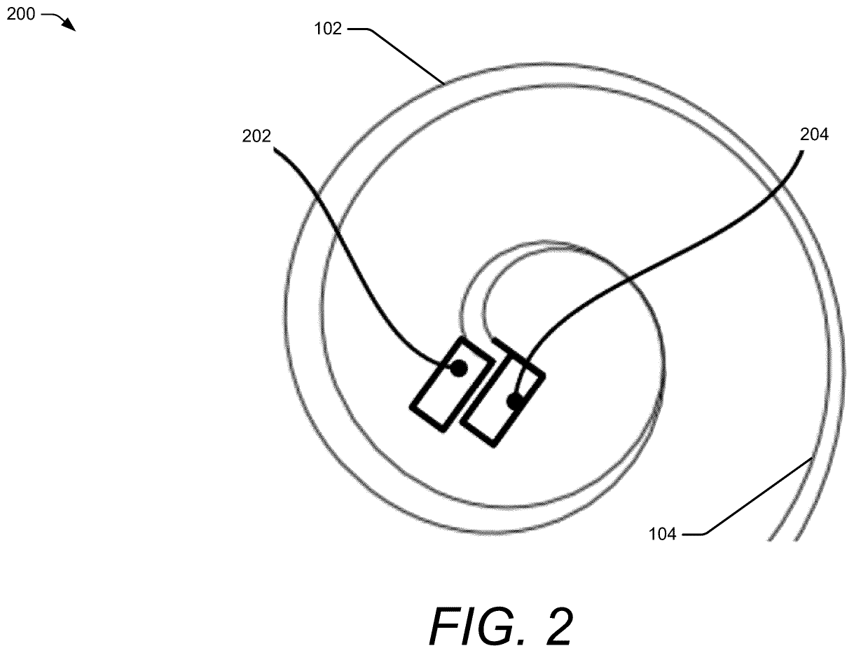

FIG. 2 illustrates an example tab placement for a low H-field tab configuration for a cylindrical-winding battery 200 (e.g., the battery 100 of FIG. 1). In some examples, the example battery 200 is arranged similarly to the example battery 100, including the wound anode layer 102 and the wound cathode layer 104. Additionally, the example battery 200 includes a first tab 202 and a second tab 204. In some examples, the first tab 202 is electrically connected to the anode layer 102 and the second tab 204 is electrically connected to the cathode layer 104. In some examples, the first tab 202 is electrically connected to the cathode layer 104 and the second tab 204 is electrically connected to the anode layer 102.

As seen in Eq. 5, even with near-equal length layers 102 and 104, there may still be some disparity, resulting in a non-trivial H-field. In addition, battery tab placement (e.g., the tabs 202 and 204) can also contribute to the overall H-field produced by the battery 200. Consider, for example, the first tab 202 connected to the anode layer 102 at the center of the battery 200 (as pictured in FIG. 2), but the second tab 204 connected to the cathode layer 104 at the outside of the battery 200. This would result in a current for the anode layer 102 and a current for the cathode layer 104 propagating in a same angular direction about a central axis (e.g., the central axis 108 of FIG. 1). Even allowing for δ=0 exactly in Eqs. 4 and 5, a net H-field would be produced (as in Eq. 2).

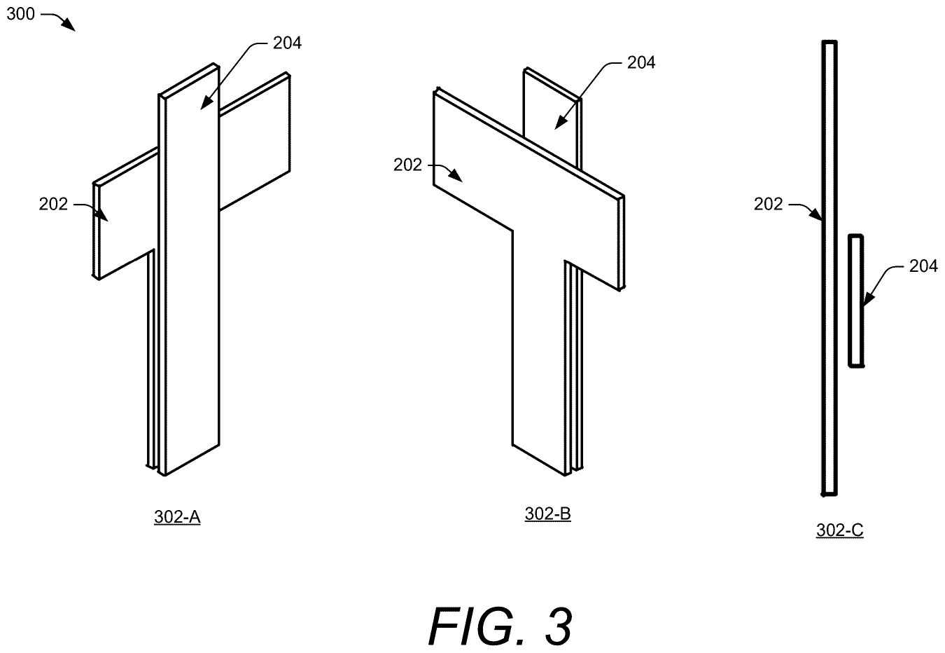

By configuring the first tab 202 and the second tab 204 in the center of the battery 200, current directionality in the anode layer 102 and the cathode layer 104 produce canceling H-fields. In existing wound battery designs, tabs may be configured to cancel an H-field produced by too great of a δ. By eliminating the H-field produced by high δ, tab configurations can be configured to cancel H-fields produced by currents in the tabs. FIG. 3 illustrates an example orientation 300 of the tabs 202 and 204 of FIG. 2 relative to one another for a low H-field tab configuration for a cylindrical-winding battery. Three views are presented in FIG. 3. A first view 302-A shows the second tab 204 of FIG. 2 overlapping the first tab 202 of FIG. 2. A second view 302-B is the same configuration, but viewed from behind (relative to the first view 302-A). A third view 302-C is a top-down view (relative to the first view 302-A and the second view 302-B).

The first tab 202 and the second tab 204 substantially overlap. The orientation 300 includes a current in the first tab 202 having an opposite propagation direction in space as a current in the second tab 204. The opposite current propagation directions produces H-fields with opposing directions. Considering the currents to have similar magnitude, the strength of the opposing H-fields will also be substantially the same. This creates a cancelation effect for the H-fields generated by the tabs 202 and 204.

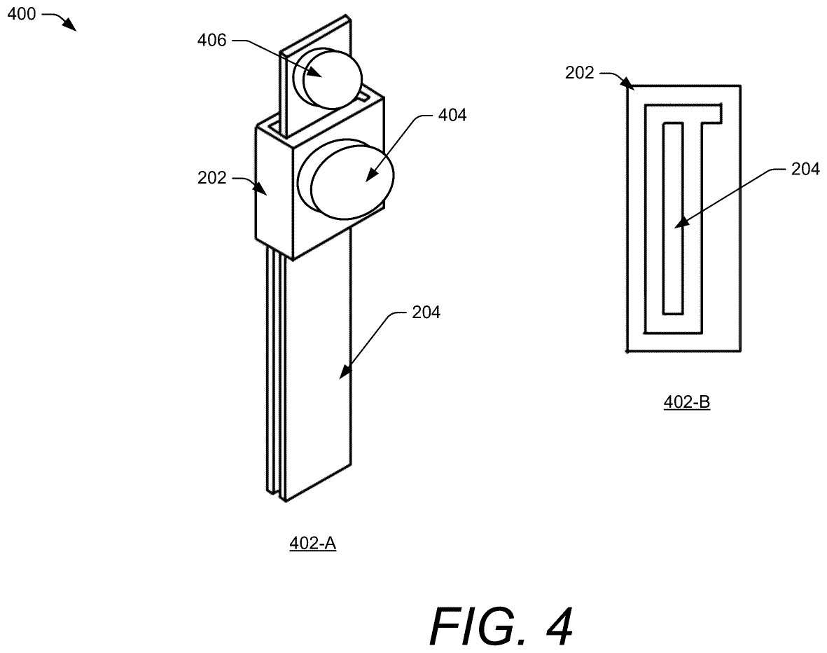

FIG. 4 illustrates an example folding 400 of one of the tabs of FIG. 3 for a low H-field tab configuration for a cylindrical-winding battery. Two views are shown, with a first view 402-A showing a front view (similar to the first view 302-A of FIG. 3) and a second view 402-B being a top-down view (relative to the first view 402-A, similar to the third view 302-C of FIG. 3). When, as in FIGS. 3 and 4, the tabs 202, 204 overlap, a challenge can be how to configure external contacts, especially if a configuration is desired that has the external contacts facing a same direction and/or on a same side of the battery (e.g., the battery 100 of FIG. 1).

The example folding 400 highlights one way to attach the external contacts. Consider the first tab 202 of FIG. 2 as shown in the first view 302-A and the second view 302-B of FIG. 3. The first tab 202 is in a “T” shape. In FIG. 4, the first tab 202 has the top of the “T” folded to encompass the second tab 204. The encompassing of the second tab 204 can be clearly seen in the view 402-B. In the view 402-A, a first external contact 404 is electrically connected to the first tab 202 (via solder, welding, a pressure molding, etc.). A second external tab 406 is similarly electrically connected to the second tab 204.

The folding of the first tab 202 to encompass the second tab 204, along with the configuration of the first external contact 404 and the second external contact 406, permits multiple advantageous configurations for the battery. For example, a casing of the battery can be selected from multiple material types without negatively affecting the total H-field. For example, a metal casing or a plastic casing can be used equivalently, in addition to other materials. Further, the configuration of the external contacts 404, 406 in the example folding 400 permit the external contacts 404, 406 to connect to a device, circuit, etc. at substantially a same point. This contrasts with traditional winding-cell batteries, which have connection points at the top and bottom of the battery.

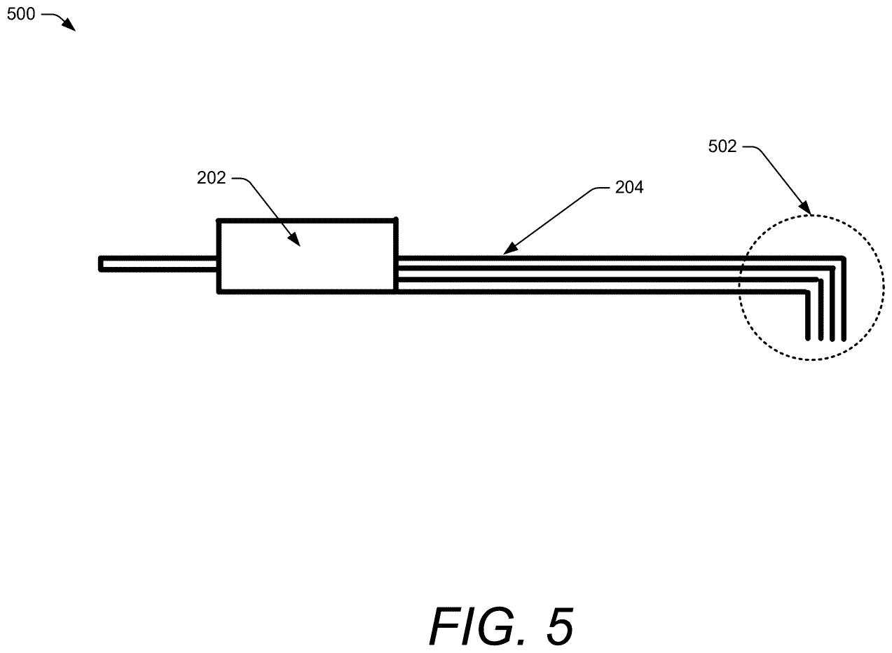

FIG. 5 illustrates an example overlap configuration 500 for the tabs of FIG. 2. The example configuration 500 can be thought of as a side-view of the first tab 202 and the second tab 204 of FIG. 2 (relative to the first view 402-A of FIG. 4). In aspects, a cancelation of the produced H-fields from the first tab 202 and the second tab 204 is correlated with an overall length of the first tab 202 and the second tab 204. In order to increase the overall length without expanding a battery (e.g., the battery 100 of FIG. 1) footprint, a bend can be made in the tabs 202, 204. Consider the region indicated by a dashed circle 502. This region contains the bend, allowing the overlap configuration 500 to elongate the tabs 202, 204.

### Example H-Field Propagation

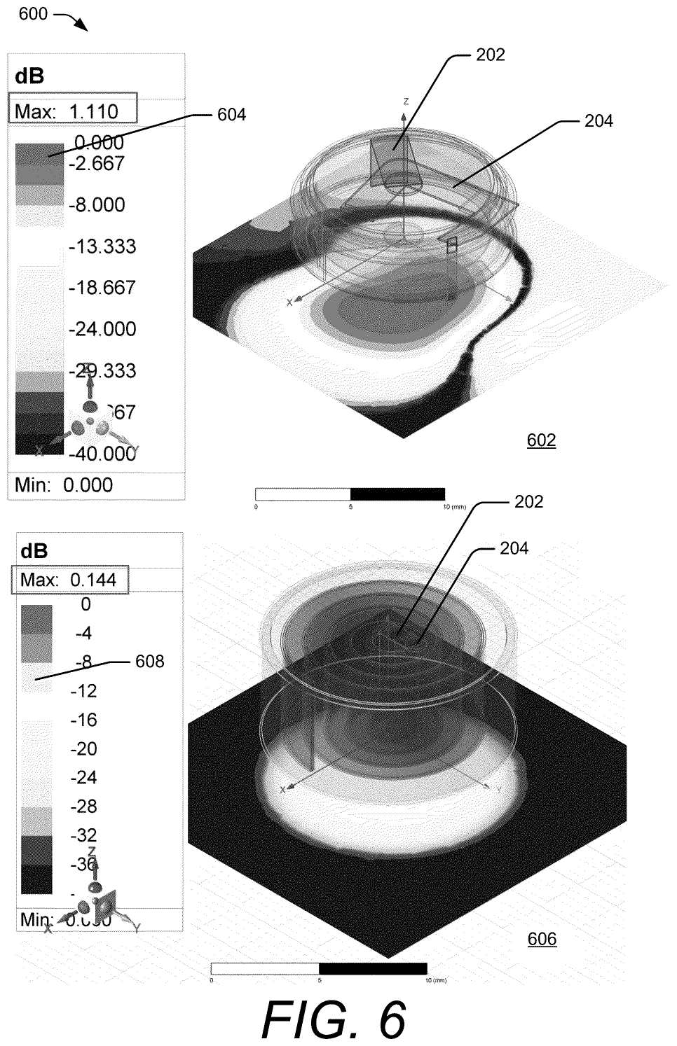

FIG. 6 illustrates a comparative H-field propagation 600 propagation between a standard tab configuration and a low H-field tab configuration for a cylindrical-winding battery. In aspects, a first density plot 602 shows a relative H-field strength in the standard configuration. As illustrated, a standard H-field scale 604 shows a relative intensity for the first density plot 602. Note that the first density plot 602, as indicated in the standard H-field scale 604, has a maximum value of 1.110 dB, indicating a relatively strong H-field propagation.

In aspects, a second density plot 606 shows a relative H-field strength in the low H-field tab configuration. The H-field for the low H-field tab configuration, according to a low-emission H-field scale 608, has a maximum value of 0.144 dB, indicating a relatively weak H-field propagation. The comparative H-field propagation 600 illustrates the H-field for the low H-field tab configuration as ˜13% of the H-field of the standard configuration. Further, the shape of the H-field propagation in the first density plot 602 compared with the shape of the H-field propagation in the second density plot 606 shows the low H-field tab configuration may have a smaller footprint, a greater symmetry, and a decreased range for the total H-field of the battery (e.g., the battery 100 of FIG. 1) compared with the standard tab configuration.

### CONCLUSION

Although aspects of a low H-field tab configuration for a cylindrical-winding battery have been described in language specific to features and/or methods, the subject of the appended claims is not necessarily limited to the specific features or methods described. Rather, the specific features and methods are disclosed as example implementations of techniques for low H-field tab configuration for a cylindrical-winding battery, and other equivalent features and methods are intended to be within the scope of the appended claims. Further, various different aspects are described, and it is to be appreciated that each described aspect can be implemented independently or in connection with one or more other described aspects.

What is claimed is:

1. A battery having a symmetry about an axis and comprising:
a plurality of layers, the plurality of layers:
comprising alternating cathode and anode layers, the alternating cathode and anode layers electrically isolated from one another; and
disposed such that the plurality of layers define a cylindrical-winding roll about the axis;
a first tab electrically connected to a first layer of the plurality of layers, the first layer having a first polarity; and
a second tab electrically connected to a second layer of the plurality of layers, the second layer having a second polarity opposite to the first polarity and the second tab configured to overlap the first tab.

2. The battery of claim 1, wherein the first layer is an anode layer and the second layer is a cathode layer.

3. The battery of claim 1, wherein the first layer is a cathode layer and the second layer is an anode layer.

4. The battery of claim 1, wherein:
the first tab comprises a connected section; and
the connected section of the first tab encompasses at least a portion of the second tab.

5. The battery of claim 4, wherein a size of the connected section of the first tab is based on an amount of overlap of the at least the portion of the second tab encompassed by the connected section of the first tab.

6. The battery of claim 1, further comprising:
a first external contact electrically connected to the first tab; and
a second external contact electrically connected to the second tab.

7. The battery of claim 6, wherein:
the first external contact is connected to the first tab with a first solder connection; and
the second external contact is connected to the second tab with a second solder connection.

8. The battery of claim 1, wherein:
the plurality of layers comprises:
one anode layer having a first length; and
one cathode layer having a second length; and
a difference between the first length and the second length is below a threshold length.
